(19) United States
(12) Patent Application Publication
(10) Pub. No.: US 2014/0227156 A1
(43) Pub. Date: Aug. 14, 2014

(54) DIESEL OXIDATION CATALYST AND METHOD OF TREATING ENGINE EXHAUST GAS

(71) Applicants: John C. Gibble, Greencastle, PA (US); Chun Tai, Hagerstown, MD (US); Jeffrey A Huber, Williamsport, MD (US)

(72) Inventors: John C. Gibble, Greencastle, PA (US); Chun Tai, Hagerstown, MD (US); Jeffrey A Huber, Williamsport, MD (US)

(73) Assignee: Mack Trucks Inc., Greensboro, NC (US)

(21) Appl. No.: 14/345,965

(22) PCT Filed: Oct. 6, 2011
(86) PCT No.: PCT/US2011/055007

§ 371 Date: Mar. 20, 2014

(51) Int. Cl. B01D 53/94; F01N 3/24

(52) U.S. Cl. CPC B01D 53/94; F01N 3/24
USPC 423/212; 428/131; 428/134; 428/138

(57) ABSTRACT

A diesel oxidation catalyst includes an inlet side, an outlet side, and at least one channel extending from the inlet side to the outlet side, the channel including a first, non-catalyzed portion extending from the inlet side to a second, catalyzed portion. A method of treating engine exhaust gas is also provided.

### BACKGROUND AND SUMMARY

The present invention relates generally to a diesel oxidation catalyst (DOC) and method of treating engine exhaust gas and, more particularly, to a DOC having at least one channel comprising a first, non-catalyzed portion extending from an inlet side of the DOC to a second, catalyzed portion of the channel.

DOCs are subject to clogging by soot and hydrocarbon particles. These particles tend to collect at the catalyzed inlet end of the DOC. The inventors have recognized that clogging at the inlet end of the DOC can be particularly problematic because the pressure vector acting on the clog at the inlet end of the channels of the DOC tends to be perpendicular to the largest face of the clog particle which can make it difficult to dislodge the particle.

The inventors have identified the desirability of providing a DOC that facilitates avoiding clogging at the inlet end of the DOC so that particles collect, if at all, further inside the channels of the DOC, away from the inlet end.

According to an aspect of the present invention, a diesel oxidation catalyst comprises an inlet side, an outlet side, and at least one channel extending from the inlet side to the outlet side, the channel comprising a first, non-catalyzed portion extending from the inlet side to a second, catalyzed portion.

According to another aspect of the present invention, a method of treating engine exhaust gas, introducing gas exhausted from the engine into a channel of a diesel oxidation catalyst, the channel extending from an inlet side to an outlet side of the diesel oxidation catalyst, the channel comprising a first, non-catalyzed portion extending from the inlet side to a second, catalyzed portion.

### BRIEF DESCRIPTION OF THE DRAWINGS

The features and advantages of the present invention are well understood by reading the following detailed description in conjunction with the drawings in which like numerals indicate similar elements and in which:

FIG. 1 is a perspective view of a diesel oxidation catalyst according to an aspect of the present invention;

FIG. 2A is a partial side, cross-sectional view of a diesel oxidation catalyst according to an aspect of the present invention taken at section 2A-2A of the top view of the DOC shown in FIG. 2B;

FIG. 3 is a side, cross-sectional view of a channel of a diesel oxidation catalyst according to an aspect of the present invention;

FIG. 4 is a side, cross-sectional view of a channel of a diesel oxidation catalyst according to another aspect of the present invention;

FIG. 5A is a side, cross-sectional view of a channel of a diesel oxidation catalyst according to another aspect of the present invention, and FIG. 5B is a side, cross-sectional view of the channel of FIG. 5B after deactivation of a catalyst at a first portion of the channel;

FIG. 6A is a side, cross-sectional view of a diesel oxidation catalyst according to an aspect of the present invention showing a clog in a channel of the DOC; and

FIG. 6B is a side, cross-sectional view of a diesel oxidation catalyst according to the prior art showing a clog in a channel of the DOC.

### DETAILED DESCRIPTION

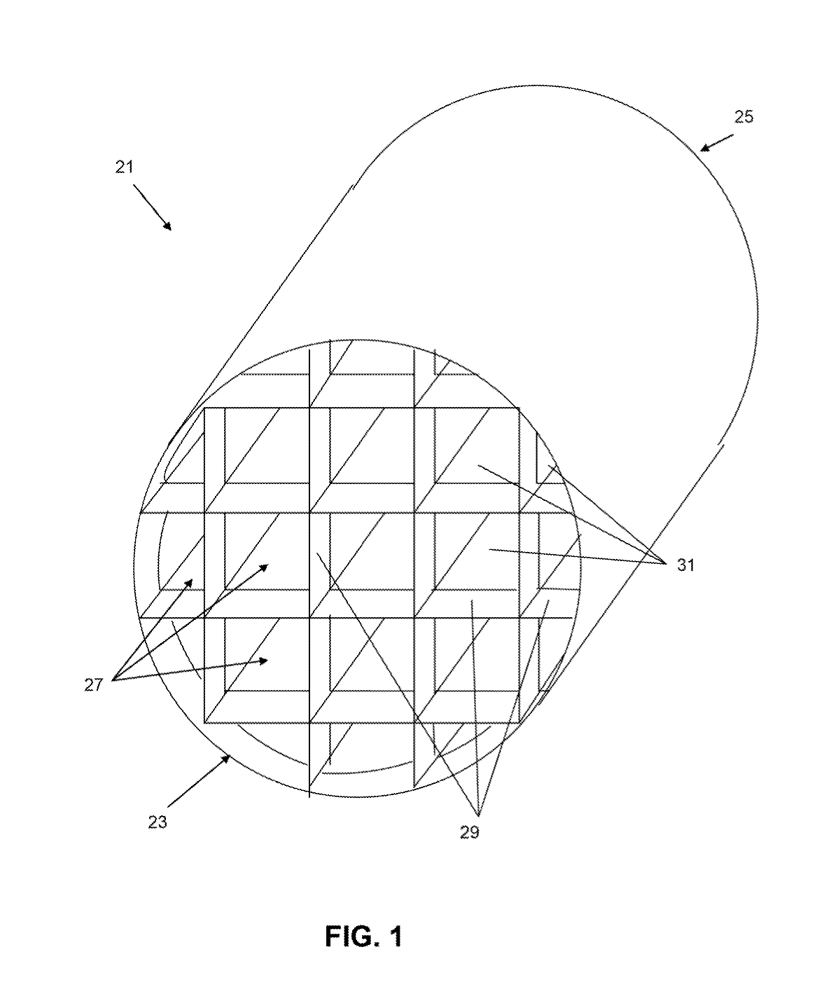

A diesel oxidation catalyst (DOC) 21 according to an aspect of the present invention shown in FIG. 1. The DOC comprises an inlet side 23, an outlet side 25, and at least one channel 27, usually a plurality of channels, extending from the inlet side to the outlet side. The channel 27 comprises a first, non-catalyzed portion 29 extending from the inlet side 23 to a second, catalyzed portion 31. Where a plurality of channels 27 are provided, ordinarily, all of the channels will have a first, non-catalyzed portion 29 and a second, catalyzed portion. The second portion 31 ordinarily extends from the first portion 29 through the length of channel, i.e., to the outlet side 25 of the channel 27. The first portion 29 of the channel 27 is ordinarily shorter than the second portion 31. Because the first portion 29 of the channel 27 is non-catalyzed, soot and hydrocarbon deposits will tend to be located deeper inside the channel by the catalyzed second portion 31 of the channel.

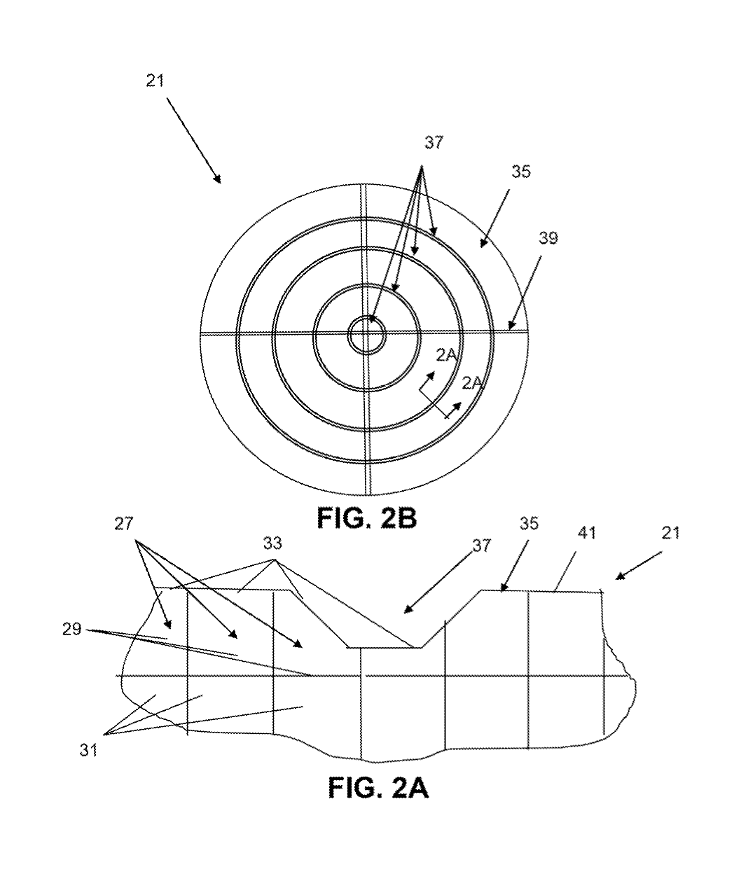

First ends 33 of the plurality of channels 27 at the inlet side 23 of the DOC at least partially define an inlet surface 35. As seen in FIG. 2A, the inlet surface 33 can be non-planar in the sense that edges defining the first ends 33 of the channels 27 need not all end in the same plane. Some of the channels 27 may, therefore, be of different lengths than other ones of the channels. A non-planar inlet surface 35 may be non-planar such that it has a non-random pattern formed therein, such as the pattern of concentric circles 37 and lines 39 of depressions disposed below a main part 41 of the inlet surface seen in FIG. 2B. The non-planar inlet surface 35 can he formed in any suitable way, such as by being formed when casting the DOC or by machining a planar surface.

Where there are a plurality of channels 27 that each have a first, non-catalyzed portion 29 and a second, catalyzed portion 31, for each of the plurality of channels, the first portion will ordinarily extend substantially the same distance from the inlet side to the second portion unless the inlet surface 35 is non-planar, in which case the first portion may not be of the same length in all channels. The second portion 31 will ordinarily be the same length for all channels because the surface of the outlet side 25 is ordinarily planar.

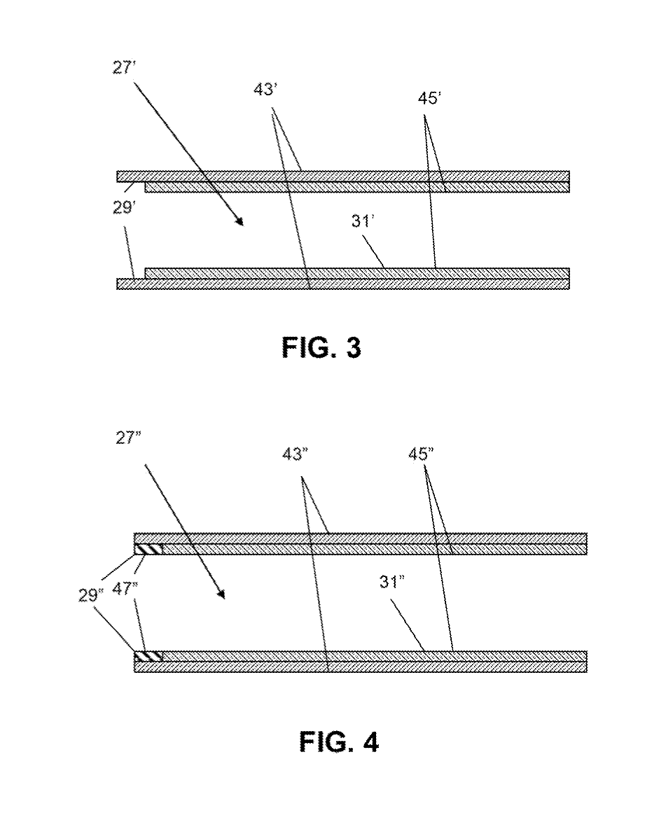

The DOC may be formed in any suitable manner. For example, as seen in FIG. 3, the DOC may comprise a substrate 43′ defining the channel 27 and at the second portion 31′ of the channel, a catalyst 45′ applied to the substrate. In the embodiment of FIG. 3, no catalyst is provided at the first portion 29′ of the channel 27, or the catalyst is removed from the substrate 43′. For example, the catalyst 45′ can be applied to the substrate 43′ by at least one of wash-coating the substrate with the catalyst and dipping the substrate in the catalyst. The first portion 29′ of the channel 27′ is not wash-coated or dipped in the catalyst so that there is only catalyst on the second portion 31′ of the channel. Alternatively, catalyst on the first portion 29′ can be removed, e.g., mechanically or chemically.

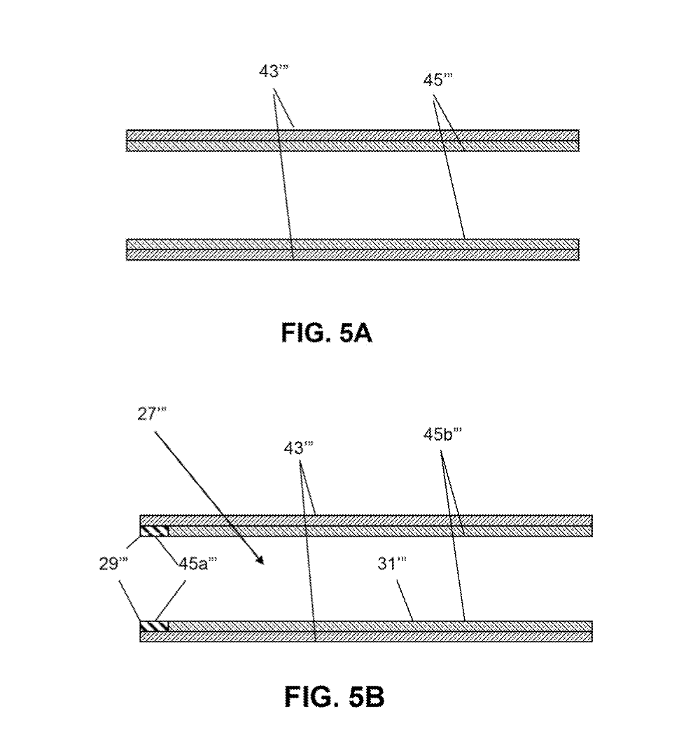

As seen in FIG. 4, the channel 27″ can have a coating 47″ to which catalyst 45″ is unable to adhere on the substrate 43″ at the first portion 29″ of the channel, while catalyst can adhere to the second portion 31″ of the channel. Alternatively, the DOC may be made by first providing a catalyst 45′″ over all surfaces of a substrate 43′″ as seen in FIG. 5A, and the first portion 29′″ of the channel 27′″ can be made non-catalyzed by thereafter deactivating the catalyst so that a deactivated catalyst 45a″′ is present at the first portion of the channel and an activated catalyst 45b′″ is present at the second portion 31′″ of the channel as seen in FIG. 5B.

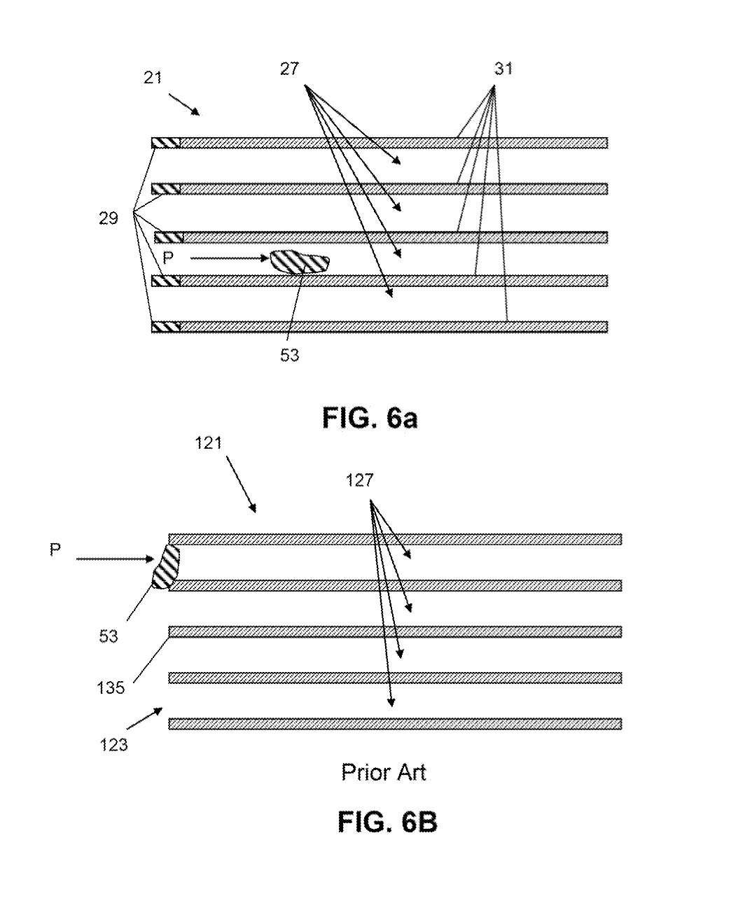

In a method of treating engine exhaust gas according to an aspect of the present invention as seen in FIG. 6A, gas is exhausted from an engine into a channel 27 of a DOC 21. The channel 27 extends from an inlet side 23 to an outlet side 25 of the DOC 21 and comprises a first, non-catalyzed portion 29 extending from the inlet side to a second, catalyzed portion 31.

While not wishing to be bound by theory, it is believed that the present invention facilitates avoiding clogs in channels of a DOC because, as seen in FIG. 6A, if clogging begins further inside a channel 27, as opposed to at the inlet end of the channel, the clog 53 will tend to increase the local space velocity of the exhaust gas in the channel, and will facilitate a breakup of the clog. Moreover, if the local exhaust gas velocity itself is not enough to release the clog 53, the pressure in the channel 27 will tend to rise until the majority of exhaust flow goes through other channels. Once all channels 27 are plugged, local pressure will rise and velocity will decrease. The clogs 53 will be resisting a pressure vector P that is substantially parallel to the main clog surface and imposes a shear force on the clog that tends to draw it away from the wall of the channel 27. Also, if the clog occurs at some point well inside the channel, the nature of the membrane forming the channel is ordinarily such that the open portion of the channel will still function, so a reduced efficiency will exist but functionality will be retained.

By contrast, as seen in FIG. 6B, if a clog 53 forms on a catalyzed inlet surface 135 at the inlet side 123 of the DOC 121, as typically occurs in conventional DOCs, increased pressure will push the clog against the channel 127 itself. Testing suggests that the clog 53 is able to resist this pressure having a pressure vector P that is perpendicular to the main surface of the clog to the point of system damage.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure material, or acts are presently considered to be essential, they are identified as such.

While this invention has been illustrated and described in accordance with a preferred embodiment, it is recognized that variations and changes may be made therein without departing from the invention as set forth in the claims.

1. A diesel oxidation catalyst, comprising:
an inlet side having an inlet face;
an outlet side; and
at least one channel extending from the inlet side to the outlet side, the channel comprising a first, non-catalyzed portion extending from the inlet face to a second, catalyzed portion.

2. The diesel oxidation catalyst as set forth in claim 1, comprising a plurality of channels extending from the inlet side to the outlet side.

3. The diesel oxidation catalyst as set forth in claim 1, wherein first ends of the plurality of channels at the inlet side of the diesel oxidation catalyst at least partially define an inlet surface.

4. The diesel oxidation catalyst as set forth in claim 3, wherein inlet surface is non-planar.

5. The diesel oxidation catalyst as set forth in claim 4, wherein the non-planar inlet surface is formed when casting the diesel oxidation catalyst.

6. The diesel oxidation catalyst as set forth in claim 4, wherein the non-planar inlet surface is formed by machining a surface.

7. The diesel oxidation catalyst as set forth in claim 4, wherein the first ends of the plurality of channels are one of recessed and non-recessed according to a non-random pattern.

8. The diesel oxidation catalyst as set forth in claim 2, wherein the plurality of channels are not all of the same length.

9. The diesel oxidation catalyst as set forth in claim 2, wherein each of the plurality of channels comprises a first, non-catalyzed portion extending from the inlet side to a second, catalyzed portion.

10. The diesel oxidation catalyst as set forth in claim 9, wherein, for each of the plurality of channels, the first portion extends substantially the same distance from the inlet side to the second portion.

11. The diesel oxidation catalyst as set forth in claim 1, comprising a substrate defining the channel and, at the second portion of the channel, a catalyst applied to the substrate.

12. The diesel oxidation catalyst as set forth in claim 11, comprising a coating to which the catalyst is unable to adhere on the substrate at the first portion of the channel.

13. The diesel oxidation catalyst as set forth in claim 11, wherein the first portion of the channel is made non-catalyzed by providing the catalyst to the substrate at the first portion of the channel and thereafter deactivating the catalyst.

14. The diesel oxidation catalyst as set forth in claim 11, wherein the first portion of the channel is made non-catalyzed by providing the catalyst to the substrate at the first portion of the channel and thereafter removing the catalyst.

15. The diesel oxidation catalyst as set forth in claim 11, wherein the catalyst is applied to the substrate by at least one of wash-coating the substrate with the catalyst and dipping the substrate in the catalyst.

16. The diesel oxidation catalyst as set forth in claim 15, wherein the first portion of the channel is not wash-coated or dipped in the catalyst.

17. The diesel oxidation catalyst as set forth in claim 1, wherein the first portion of the channel is shorter than the second portion of the channel.

18. A method of treating engine exhaust gas, comprising introducing gas exhausted from the engine o a channel of a diesel oxidation catalyst, the channel extending from an inlet side to an outlet side of the diesel oxidation catalyst, the inlet side having an inlet face, the channel comprising a first, non-catalyzed portion extending from the inlet face to a second, catalyzed portion.

19. The method of treating engine exhaust gas as set forth in claim 18, wherein the diesel oxidation catalyst comprises a plurality of channels extending from the inlet side to the outlet side, each of the plurality of channels comprising a first, non-catalyzed portion extending from the inlet side to a second, catalyzed portion, the method comprising introducing the exhausted as into each of the plurality of channels.

20. The method of treating engine exhaust gas as set forth in claim 19, wherein first ends of the plurality of channels at the inlet side of the diesel oxidation catalyst at least partially define a non-planar inlet surface so that first ends of at least some of the plurality of channels are non-perpendicular to longitudinal axes of the channels, and introducing the exhausted gas in a direction substantially parallel to the longitudinal axes of the channels.

21. A diesel oxidation catalyst, comprising:
an inlet side;
an outlet side; and
at lest one channel extending from the inlet side to the outlet side and open at the inlet side and the outlet side, the channel comprising a first, non-catalyzed portion extending from the inlet side to a second, catalyzed portion.

22. A method of treating engine exhaust gas, comprising introducing gas exhausted from the engine into a channel of a diesel oxidation catalyst, the channel extending from an inlet side to an outlet side of the diesel oxidation catalyst and open at the inlet side and the outlet side, the channel comprising a first, non-catalyzed portion extending from the inlet side to a second, catalyzed portion.
